(19) United States
(12) Patent Application Publication
(10) Pub. No.: US 2026/0148252 A1
(43) Pub. Date: May 28, 2026

(54) Dynamic Automatic Generation of Item Listings

(71) Applicant: eBay Inc., San Jose, CA (US)

(72) Inventors: Harikrishnan Kuppusamykrishnan, San Francisco, CA (US); Aaron Michael Nance, Troutdale, OR (US); Anna Monika Zaremba, Kirkland, WA (US)

(73) Assignee: eBay Inc., San Jose, CA (US)

(21) Appl. No.: 18/959,146

(22) Filed: Nov. 25, 2024

(51) Int. Cl. G06Q 30/0202; G06Q 30/0601

(52) U.S. Cl. CPC G06Q 30/0202; G06Q 30/0631

(57) ABSTRACT

Dynamic automatic generation of item listings is described. A computing device (e.g., or a user engagement system) receives input that indicates at least one item. The computing device generates a probability of user engagement with a listing of the at least one item. The computing device generates the probability based on a context associated with the at least one item. In some cases, the computing device displays a control selectable to automatically generate the listing of the at least one item based on the probability of the user engagement satisfying a threshold value. In some other cases, the computing device displays a control selectable to generate a configurable template for the listing of the at least one item based on the probability of the user engagement failing to satisfy a threshold value.

### BACKGROUND

Computing devices can implement various applications that provide functionality to users, such as online marketplaces for buying and selling items. These applications often utilize machine learning and/or artificial intelligence techniques to process input data and generate useful outputs. The application can implement one or more learning models, such as artificial intelligence models and/or machine learning models, to capture patterns and relationships in data, enabling the models to make predictions or decisions on new, unseen data.

### SUMMARY

A system (e.g., a user engagement system) receives input indicating at least one item and generates a probability of user engagement with a listing of the item based on associated context. For example, the context may include factors, such as current market trends and historical user engagement data for the item or for similar items. In some cases, the context may also include seasonal variations, geographic locations of users, or recent search queries related to the item. The system may train learning models using historical data to output engagement probabilities and/or the threshold values. If the probability satisfies a threshold value, a control is displayed to automatically generate the listing. When selected, the system can automatically complete listing fields using generated information. In some examples, if the probability fails to satisfy the threshold value, a configurable template may be provided for manual completion (e.g., from scratch). The system can continuously retrain models using updated engagement data to improve listing optimization over time.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts a procedure in an example implementation of dynamic automatic generation of item listings.

FIG. 3 depicts an example of a user interface for listing a single item based on user engagement.

FIG. 4 depicts an example of a user interface for listing multiple items based on user engagement.

FIGS. 5 and 6 depict procedures in example implementations of dynamic automatic generation of item listings.

FIG. 7 illustrates an example of a system that includes an example computing device that is representative of one or more computing systems and/or devices that may implement the various techniques described herein.

### DETAILED DESCRIPTION

### Overview

A system for listings items based on user engagement (e.g., market dynamics) is described. The system (e.g., a user engagement system) receives input indicating one or more items and generates a probability of user engagement with a listing for that item based on associated context, such as current market trends and historical user engagement data. If the probability satisfies a threshold value, then the system displays a control to automatically generate the listing. When selected, the system can automatically complete listing fields using generated information. If the probability fails to satisfy the threshold value, then a configurable template may be provided for manual completion.

Some conventional online marketplace systems often rely on manual processes for creating item listings, which can be time-consuming and inefficient. For example, a seller may manually input detailed information to list respective items, including descriptions, pricing, and other relevant details. However, manually inputting detailed information may lead to inconsistencies or errors in information used in a listing of an item, resulting in increased signaling overhead and usage of computational resources (e.g., processing resources, memory resources, and power consumption) due to exchange of corrected information and/or exchange (e.g., return, replacement) of items. Some other conventional online marketplace systems may implement basic automation features for listing creation. However, the conventional online marketplace systems may apply the automation features regardless of the item being listed, such that each item is processed in a same or similar manner. For example, conventional automation features may not analyze real-time market trends (e.g., conditions, dynamics) or historical user engagement data to predict the likelihood of user engagement with a listing of an item prior to automatically creating an item listing. The lack of dynamic automation of item listing using market trends and historical user engagement data can lead to an inefficient use of computational resources by applying automation features for listings of items with a low probability or likelihood of user engagement.

As described herein, to reduce the use of computational resources related to automatically generating item listings, a system for listings items based on user engagement may implement a dynamic (e.g., configurable) approach to automatically generating item listings. The system may receive input from a device that indicates one or more items (e.g., one or more images of the one or more items). The input may be in the form of an image, a video, text, or any other digital content or data representative of the items. For example, a computing device may capture one or more images of the items and may send the images to the system for processing. The system may generate a probability (e.g., likelihood) of user engagement with a listing of the items. For example, the system may use one or more learning models (e.g., artificial intelligence (AI) models and/or machine learning (ML) models) to analyze the items and a corresponding context of the items to determine the probability of the user engagement with the listing of the items. The context may include, but is not limited to, current (e.g., real-time, actual) market trends for the items, current market trends for related items (e.g., items in a same category), historical user engagement data with the items, historical user engagement data with related items, and other relevant factors.

If the probability satisfies (e.g., meets, is greater than) a defined threshold value, then the system displays a control that provides for automatic generation of the listing. When selected, the control triggers the system to automatically complete the fields of the listing using generated information. If the probability fails to satisfy (e.g., fails to meet, is below) the threshold value, then the system provides a control that provides for generation of a configurable template for manual completion. In some examples, the system may implement a tiered approach, where the system automatically completes a portion of the template if the probability satisfies (e.g., meets, is greater than) one or more additional threshold values. Additionally, or alternatively, the system may process multiple items concurrently or simultaneously, enabling bulk listing capabilities.

By considering market trends and user engagement to automatically list an item dynamically (e.g., according to a probability of user engagement with the item), the system may improve computational resource allocation for listing creation, as well as reduce the time items remain listed. The system may prioritize automatic listing generation for items with a relatively high predicted probability of user engagement (e.g., greater than a threshold value), which may include dynamically allocating computational resources to generate the listings of the items with the relatively high predicted probability of user engagement rather than items with a relatively low predicted probability of user engagement. Dynamically allocating computational resources may reduce or eliminate computational resource usage for items with relatively low predicted probability of user engagement. Additionally, or alternatively, by leveraging market trends and historical user engagement data, the system may generate information for completing listings that improves user engagement and reduces listing durations, freeing up computational resources. The system may publish the listing during a predicted peak user engagement period, which may maximize user engagement with the listing and may reduce a listing duration for an item.

In some aspects, the techniques described herein relate to a computer-implemented method including receiving input indicating at least one item, generating, based on a context associated with the at least one item, a probability of user engagement with a listing of the at least one item, and displaying, based on the probability of the user engagement satisfying a threshold value, a control selectable to automatically generate the listing of the at least one item.

In some aspects, the techniques described herein relate to a computer-implemented method, further including obtaining data corresponding to respective contexts associated with a plurality of items including the at least one item, and training, using the data, at least one learning model to output the probability of the user engagement with the listing of the at least one item based on the input indicating the at least one item and the context associated with the at least one item.

In some aspects, the techniques described herein relate to a computer-implemented method, further including obtaining updated data corresponding to an updated context associated with the at least one item, where the updated data corresponds to the user engagement with the listing of the at least one item, and retrain, using the updated data, the at least one learning model to output an updated probability of the user engagement with the listing of the at least one item based on the input indicating the at least one item and the updated context associated with the at least one item.

In some aspects, the techniques described herein relate to a computer-implemented method, further including receiving, at the control, a selection to generate the listing of the at least one item, generating the listing of the at least one item, and displaying the listing of the at least one item with an additional control selectable to publish the listing of the at least one item.

In some aspects, the techniques described herein relate to a computer-implemented method, where generating the listing of the at least one item further includes obtaining an output from at least one learning model that indicates information associated with the listing of the at least one item, where the information includes one or more of a description of the at least one item, a category of the at least one item, a value of the at least one item, or a condition of the at least one item, and automatically completing, using the information, a plurality of fields of a configurable template for the listing of the at least one item.

In some aspects, the techniques described herein relate to a computer-implemented method, further including obtaining, as output from a learning model, the threshold value.

In some aspects, the techniques described herein relate to a computer-implemented method, further including receiving additional input indicating the threshold value.

In some aspects, the techniques described herein relate to a computer-implemented method, where the input includes one or more images of the at least one item.

In some aspects, the techniques described herein relate to a computer-implemented method, where the context associated with the at least one item is based on one or more of an average value associated with the at least one item, an average value associated with one or more items related to the at least one item, a volume of user engagement with the at least one item, or a volume of user engagement with the one or more items related to the at least one item.

In some aspects, the techniques described herein relate to a system including one or more processors, and a computer-readable storage medium storing instructions that are executable by the one or more processors to perform operations including receiving input indicating at least one item, generating, based on a context associated with the at least one item, a probability of user engagement with a listing of the at least one item, and displaying, based on the probability of the user engagement satisfying a threshold value, a control selectable to automatically generate the listing of the at least one item.

In some aspects, the techniques described herein relate to a computer-implemented method including receiving input indicating at least one item, generating, based on a context associated with the at least one item, a probability of user engagement with a listing of the at least one item, and displaying, based on the probability of the user engagement failing to satisfy a threshold value, a control selectable to generate a configurable template for the listing of the at least one item.

In some aspects, the techniques described herein relate to a computer-implemented method, further including obtaining data corresponding to respective contexts associated with a plurality of items including the at least one item, and training, using the data, at least one learning model to output the probability of the user engagement with the listing of the at least one item based on the input indicating the at least one item and the context associated with the at least one item.

In some aspects, the techniques described herein relate to a computer-implemented method, further including obtaining updated data corresponding to an updated context associated with the at least one item, where the updated data corresponds to the user engagement with the listing of the at least one item, and retrain, using the updated data, the at least one learning model to output an updated probability of the user engagement with the listing of the at least one item based on the input indicating the at least one item and the updated context associated with the at least one item.

In some aspects, the techniques described herein relate to a computer-implemented method, further including receiving, at the control, a selection to generate the configurable template for the listing of the at least one item, generating the configurable template for the listing of the at least one item, and displaying the configurable template for the listing of the at least one item, where the configurable template includes a plurality of fields for completion.

In some aspects, the techniques described herein relate to a computer-implemented method, where further including obtaining additional input that indicates information associated with the listing of the at least one item, where the information includes one or more of a description of the at least one item, a category of the at least one item, a value of the at least one item, or a condition of the at least one item, completing, using the information, the plurality of fields, and displaying the listing of the at least one item with an additional control selectable to publish the listing of the at least one item.

In some aspects, the techniques described herein relate to a computer-implemented method, further including refraining from displaying an additional control selectable to automatically generate the listing of the at least one item based on the probability of the user engagement failing to satisfy the threshold value.

In some aspects, the techniques described herein relate to a computer-implemented method, further including obtaining, as output from a learning model, the threshold value.

In some aspects, the techniques described herein relate to a computer-implemented method, further including receiving additional input indicating the threshold value.

In some aspects, the techniques described herein relate to a computer-implemented method, where the input includes one or more images of the at least one item.

In some aspects, the techniques described herein relate to a computer-implemented method, where the context associated with the at least one item is based on one or more of an average value associated with the at least one item, an average value associated with one or more items related to the at least one item, a volume of user engagement with the at least one item, or a volume of user engagement with the one or more items related to the at least one item.

### Example of an Environment

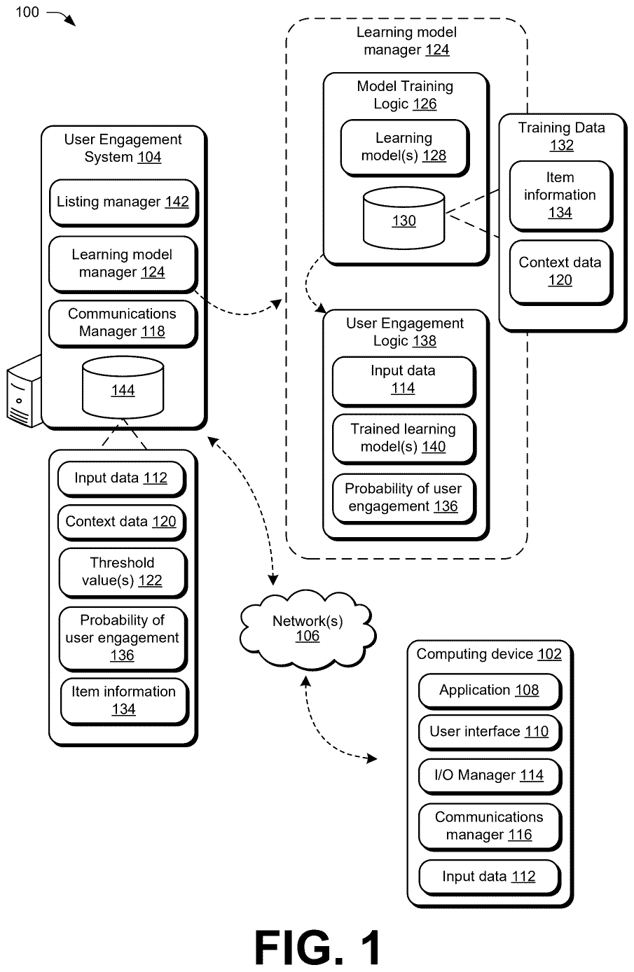

FIG. 1 is an illustration of an environment 100 in an example implementation that is operable to implement techniques described herein. The environment 100 includes a computing device 102 and a user engagement system 104. In one or more implementations, the computing device 102 and the user engagement system 104 may be communicatively coupled via one or more networks 106. An example of the networks 106 is the Internet, although the computing device 102 and the user engagement system 104 may be communicatively coupled using one or more different connections or different networks 106 (e.g., wireless networks) in various implementations.

Although the user engagement system 104 is depicted in the environment 100 as being separate from the computing device 102, in one or more implementations, an entirety, or various portions of the user engagement system 104 may be implemented at or by the computing device 102. In at least one implementation, for example, at least a portion of the user engagement system 104 may be implemented by an application 108 of the computing device 102 and/or using various resources of the computing device 102, such as hardware resources, an operating system, firmware, and so forth. Alternatively, or additionally, or alternatively, the user engagement system 104 may be implemented by server-based storage resources, processing resources, and so on of devices other than the computing device 102. For example, at least a portion of the user engagement system 104 may be implemented using a third-party service, such as a web services platform that provides one or more hardware and/or other computing resources to support provision of services by web service providers. In variations, an entirety, or various portions of the user engagement system 104 may be implemented at or by a device of the user (e.g., a mobile device, a laptop, a wearable device, or any other device).

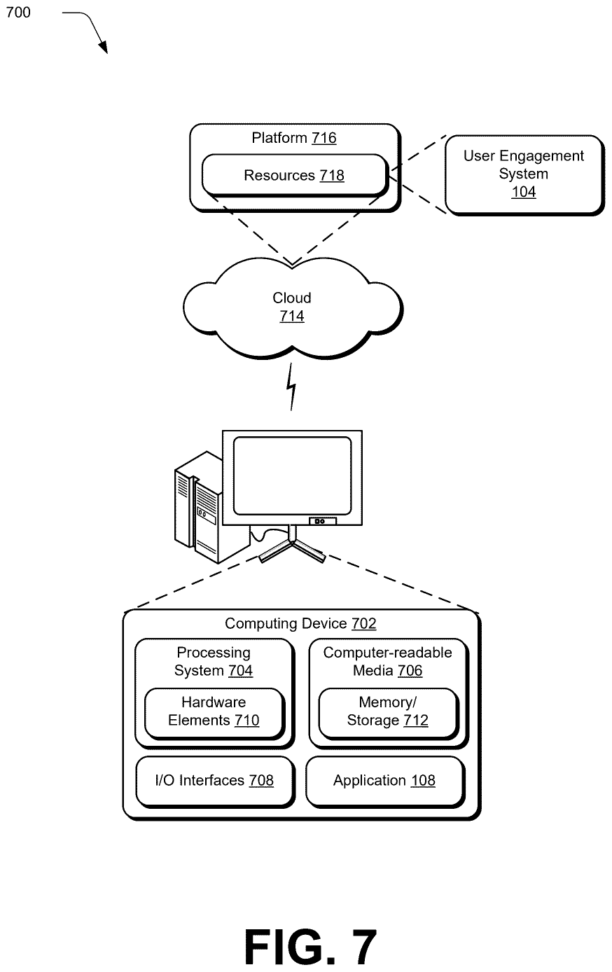

A computing device 102 that implements the environment 100 is configurable in a variety of ways. A computing device 102, for example, may be configurable as a desktop computer, a laptop computer, a mobile device (e.g., assuming a handheld configuration such as a tablet or mobile phone), an IoT device, a wearable device (e.g., a smart watch, a ring, or smart glasses), an augmented reality and/or virtual reality device (e.g., the smart glasses), a server, and so forth. Thus, a computing device 102 may range from full resource devices with substantial memory and processor resources to low-resource devices with limited memory and/or processing resources. Although in instances in the following discussion reference is made to a computing device 102 in the singular, a computing device 102 may also be representative of multiple different devices, such as multiple servers of a server farm utilized to perform operations “over the cloud” as further described in relation to FIG. 7.

In at least one implementation, the application 108 may support communication of data across the networks 106 between the computing device 102 and the user engagement system 104. By supporting such data communication, the application 108 may provide a respective user of the computing device 102 (e.g., and users of other computing devices) access to listing functionality for one or more items. For example, the computing device 102 may receive listing data from the user engagement system 104. Based on the received listing data, the application 108 may cause various systems of the computing device 102 to output one or more user interfaces 110, such as by displaying the user interfaces 110 via display devices or making accessible voice-based user interfaces. In some cases, the application 108 may be an online marketplace application, such as an e-commerce platform, auction site, or peer-to-peer selling platform, where users can list, buy, and sell various items. The application 108 may also include or interface with social media platforms with marketplace features or specialized marketplaces for categories of items like electronics, fashion, or collectibles.

Through interaction of a user with the computing device 102, the application 108 may receive user input (e.g., input data 112) via the user interfaces 110. Examples of such input may include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. One example of the application 108 is a browser or other web application that facilitates user interaction with listing functionality. Another example of the application 108 is a web-based computer application that facilitates user interaction with listing functionality, such as a mobile application or a desktop application. The application 108 may be configured in different ways, which provide for users to interact with the computing device 102 and by extension perform actions to view, create, or otherwise interact with item listings, without departing from the spirit or scope of the techniques described herein.

The input data 112 can include data for identifying one or more items to be listed. For example, the input data 112 may include one or more images of the items, textual descriptions of the items, videos of the items, digital content describing the item, or any other data that provides for the user engagement system 104 to detect (e.g., determine, identify) one or more items to be listed. In some cases, the computing device 102 may collect (e.g., obtain, receive) the input data 112 through user interaction with one or more components of the user interface 110 output by the application 108 on the computing device 102. Additionally, or alternatively, the input data 112 may be automatically captured by one or more sensors (e.g., camera sensors) of the computing device 102. For example, the computing device 102 may detect that there are one or more items in a live feed of a camera stream and may automatically capture an image of the items. The computing device 102 may provide the image of the items as input data 112 to the user engagement system 104.

In some cases, the computing device 102 may use computer vision techniques to identify objects (e.g., items) in the camera feed and trigger the image capture when items are recognized. The computer vision techniques may include, but are not limited to, object detection algorithms, such as convolutional neural networks (CNNs) for identifying and localizing objects within an image, feature extraction for detecting distinctive features of objects, and image segmentation techniques, such as semantic segmentation or instance segmentation, for separating objects from a background of an image, video, or live feed. Additionally, or alternatively, the computer vision techniques may utilize optical character recognition (OCR) to extract text information from images, video, or live feed (e.g., live camera feed, live stream) of items, which the computing device 102 may use for identifying item labels or descriptions. The automatic capture may also be triggered by user actions, such as placing an item on a designated surface or making a defined gesture (e.g., recognized by the computer vision techniques) in front of the camera. If the input data includes a video, then the user engagement system 104 may preprocess the video frame by frame to detect items in the respective frames of the video.

In some examples, the I/O manager 114 may receive the input data 112 via one or more controls or interactable elements (e.g., components) of the user interface 110. The input data 112 may be received in response to a request for user input from the computing device 102 and/or may be initiated by a user of the computing device 102. Examples of such user input may include, but are not limited to, receiving touch input in relation to portions of a displayed user interface, receiving one or more voice commands, receiving typed input, receiving mouse or stylus input, and so forth. For example, the user input can include a request to create a listing for one or more items, a request to view existing listings, an indication to modify listing details, or any other user input related to item listing functionality.

The communications manager 116 at the computing device 102 and the communications manager 118 at the user engagement system 104 may support communication of data (e.g., the input data 112) across the networks 106 between the computing device 102 and the user engagement system 104. By supporting such data communication, the communications manager 116 and the communications manager 118 may provide for the exchange (e.g., transmission and/or reception) of information, including the input data 112, context data 120, and one or more threshold values 122, between the computing device 102 and the user engagement system 104. Thus, the user engagement system 104 may receive input data 112 from the computing device 102, process the input data 112 along with relevant context data 120, and provide dynamically automate listing generation using the threshold values 122. In some cases, the context data 120 may include information related to the current market conditions (e.g., trends) and historical engagement data for items indicated by the input data 112 and/or items related to (e.g., similar to, in a same category as, used in accordance with) the items. The market trends may include factors, such as average selling prices of items in an online marketplace, maximum selling prices of items in the online marketplace, minimum selling prices of items in the online marketplace, current user engagement trends with listings in the online marketplace, seasonal variations in user engagement and/or listings of items in the online marketplace, and historical user engagement metrics for comparable (e.g., related, similar) listings. The context data 120 may provide information for the user engagement system 104 to assess (e.g., predict, obtain) a probability of user engagement with a new listing.

In some cases, user engagement with a listing may include various interactions between users and the item listing. Examples of user engagement may include, but is not limited to, viewing the listing details, clicking on or enlarging fields (e.g., images) of the listing, adding an item listing to a watchlist or favorites, sharing the listing on social media platforms, contacting an owner of the listing for more information about the item, placing a bid on the item in an auction-style listing, making an offer on the item, purchasing the item outright, leaving feedback or reviews after a transaction, comparing the listing with similar items, saving the listing for later viewing, participating in feedback related to the listing, reporting issues or concerns with the listing, and recommending the listing to other users. The user engagement may be tracked and analyzed by the user engagement system 104 to assess the probability of user engagement with a new listing.

The user engagement system 104 may use one or more defined threshold values 122 to determine whether to recommend automatic listing generation or provide a manual listing template. The threshold values 122 may be set based on historical performance data of item listings (e.g., item listings for a same item or related item), user defined preferences, or may be preconfigured by the user engagement system 104 or a third-party system.

The user engagement system 104 may periodically update the threshold values 122 based on analysis of listing performance and user engagement data. In some cases, the user engagement system 104 may employ an algorithm or model, such as an AI or ML model, to dynamically adjust the threshold values 122. For example, the user engagement system 104 may configure (e.g., train) the algorithm or model to analyze historical data on user engagement with listings to identify the threshold values 122. The user engagement system 104 may also analyze one or more factors, such as seasonal trends, item categories, or geographic variations, when updating the threshold values 122. In some cases, the learning model may use techniques like reinforcement learning to continuously improve the threshold values 122 based on real-time marketplace performance metrics. The performance metrics may include, but are not limited to, click-through rates, conversion rates, average time spent viewing listings, number of user inquiries, and user engagement volume for similar or related items.

The learning model manager 124 at the user engagement system 104 may implement model training logic 126 to train one or more learning models 128. The model training logic 126 may access a data storage 130 to obtain training data 132 for training the learning models 128. This training data 132 may include item information 134 and context data 120, which may include historical listing data, user engagement metrics, and market trend information. The model training logic 126 may use various machine learning techniques, such as supervised learning, unsupervised learning, or reinforcement learning, to update the parameters of the learning models 128. This process may involve techniques like gradient descent, backpropagation, or ensemble methods to improve the predictive capabilities of the learning models 128. In some cases, the training data 132 may include item information 134 for items listed at an online marketplace application (e.g., the application 108). The item information 134 may include, but is not limited to, item descriptions, item categories, item features, and pricing information for the item (average price, maximum price, minimum price, etc.), among other examples.

The model training logic 126 may use the item information 134 and the context data 120 to train the learning models 128 to output a probability of user engagement 136 for new listings. The training process may involve providing the training data 132 as input to the learning models 128 and updating weights and biases of the learning models 128 using either labels included in the training data 132 (e.g., for supervised learning, where the item information 134 may include a probability of user engagement 136 label) and/or patterns in the training data 132 (e.g., for unsupervised learning). In some examples, the learning models 128 may include gradient boosting models, deep neural networks (e.g., CNNs), and recurrent neural networks (RNNs) or transformers (e.g., for processing sequential data, such as user browsing history or time-series market data, to capture temporal patterns that influence user engagement).

The learning model manager 124 may implement user engagement logic 138 to process input data 112 using trained learning models 140 to generate a probability of user engagement 136. The probability of user engagement 136 may represent a likelihood of a listing receiving user engagement (e.g., interaction) according to a current context and item characteristics. For example, the trained learning models 140 may receive the input data 112, which may be an image of one or more items, as input. The trained learning models 140 may perform a multi-step process to generate the probability of user engagement 136. The trained learning models 140 may extract information from the input data 112 that identifies the item (a category of the item, a brand of the item, one or more item features, a quality of the item, a condition of the item, etc.).

The trained learning models 140 may use the extracted information to classify the items into a probability category according to a context of the items (e.g., a market trend detected by the trained learning models 140 using the context data 120). For example, if the input data 112 is an image of a shoe, then the trained learning models 140 may identify that the item is a shoe and extract relevant features, such as brand, style, color, and condition. The trained learning models 140 may then analyze current market trends for the shoe or for similar shoes using the context data 120, such as average prices, seasonal demand patterns, and recent user engagement metrics for comparable listings. The user engagement system 104 may obtain the context data 120 via the networks 106 and/or via the computing device 102. For example, the computing device 102 may obtain the context data 120 from the application 108 and/or one or more other applications and may report the context data 120 to the user engagement system 104. The trained learning models 140 may use natural language processing to analyze the context data 120 (recent product reviews, social media data, user engagement data, etc.) to detect market trends for the item. The trained learning models 140 may also utilize time series analysis to identify seasonal patterns in the context data 120. Based on this analysis, the trained learning models 140 may generate a probability of user engagement 136 for a potential listing of the shoe. For example, if the shoe is a brand with relatively high user engagement (e.g., greater than a threshold user engagement) in good condition during a peak user engagement season, then the trained learning models 140 may assign a relatively high probability of user engagement 136 to the shoe. In some other examples, if the shoe is a brand or style with relatively low user engagement (e.g., less than a threshold user engagement), then the trained learning models 140 may assign a relatively low probability of user engagement 136 to the shoe. The user engagement system 104 may use the probability of user engagement 136 to determine whether to recommend automatic listing generation or provide a manual listing template for the shoe.

The user engagement system 104 may store the probability of user engagement 136, the input data 112, the context data 120, the threshold values 122, and the item information 134 at a data storage 144. The data storage 130 and the data storage 144 may represent one or more databases and/or other types of storage capable of storing the relevant data. Examples may include, but are not limited to, mass storage and virtual storage. In one or more implementations, for example, the data storage 130 and 144 may be virtualized across multiple data centers and/or cloud-based storage devices. A listing manager 142 at the user engagement system 104 may access the data storage 144 to obtain the threshold values 122 and the probability of user engagement 136. The listing manager 142 may then compare the probability of user engagement 136 to one or more of the threshold values 122 to determine whether to recommend automatic listing generation for an item. For example, if the probability of user engagement exceeds a threshold value, then the listing manager 142 may trigger the display of a control on the user interface 110 of the computing device 102 that provides for automatic listing generation. In some other examples, if the probability of user engagement is less than a threshold value, then the listing manager 142 may trigger the display of a control on the user interface 110 of the computing device 102 that provides for a user to manually complete a configurable template for the listing generation.

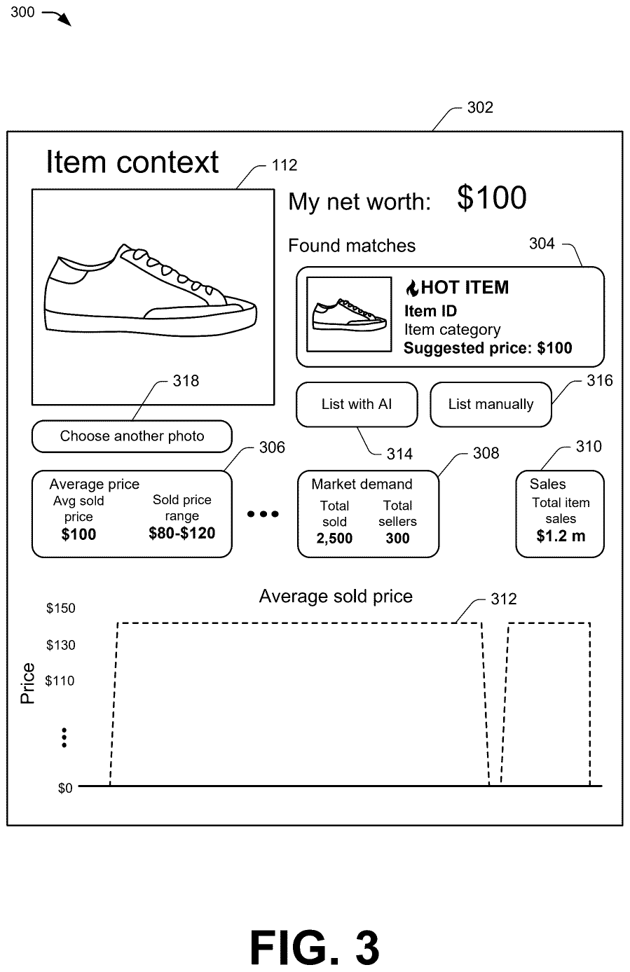

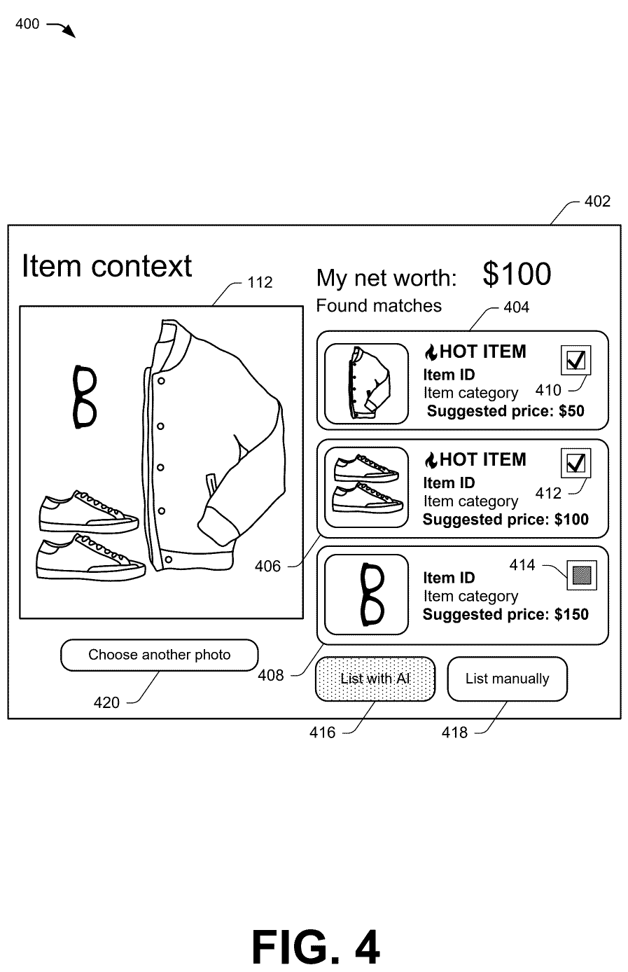

In some examples, when the control for automatically generating the item listing is displayed on the user interface 110, a user may interact with the control to initiate the automatic listing process, which is described in further detail with respect to FIGS. 3 and 4. For example, the computing device 102 may receive input at the control and may send a request to the user engagement system 104 (e.g., or to another system that supports an online marketplace application) to generate the listing. The user engagement system 104 may then utilize the item information 134 (e.g., obtained from the trained learning models 140) to automatically populate listing fields with relevant information extracted from the input data 112 and the context data 120. Populating the listing fields may include, but is not limited to, generating a description of the item (including a title, item features, condition, one or more images of the item, etc.), setting a price, selecting one or more categories, and selecting one or more listing parameters (timing for publishing the listing, shipping options, etc.). The user engagement system 104 may also suggest (e.g., recommend, display) additional features to improve user engagement with the listing. Examples of the additional features may include, but is not limited to, a request for higher quality images, a request for additional details for the item descriptions, a pricing chart (e.g., including a pricing range and average pricing for the item), or targeted keywords. In some cases, the user engagement system 104 may also recommend timing the listing during predicted peak engagement periods to potentially increase visibility and user interaction.

In some cases, once the user engagement system 104 automatically generates the listing, the computing device 102 presents the listing to the user (e.g., via the user interface 110) for review and approval before publication, providing for user input that indicates adjustments or customizations to the listing. In some other cases, once the user engagement system 104 automatically generates the listing, the user engagement system 104 publishes the listing without additional review (e.g., based on user defined settings). Publishing the listing may include making the item information visible and accessible to other users of an online marketplace application or platform (e.g., the application 108). The process may include indexing the listing in a search database of the online marketplace application or platform, assigning the listing to relevant categories, and activating any features selected for the listing. Once published, one or more users of the online marketplace application may interact with or engage with the listing by searching for the listing, selecting (e.g., clicking on) the listing, viewing the listing, purchasing the item via the listing, providing feedback for (e.g., a review of) the item or the listing, or any other action performed by the user in relation to the listing. The listing may be a listing for sale of the item via the online marketplace application.

In some examples, when the user interface 110 displays the control for completing a configurable template for the listing generation, a user may interact with the control to initiate a manual listing process. Upon receiving input at the control, the computing device 102 may present a configurable template with various fields for the user to complete. The template may include sections for item description, pricing, condition, shipping options, and other relevant details. The user engagement system 104 may may dynamically adjust the display of the template at the computing device 102 based on the item category or user input, displaying or hiding one or more of the fields. Once the user completes the template, the computing device 102 may display one or more interactable elements or controls selectable to preview the listing, make adjustments, and then submit the listing for publication or publish the listing.

The user engagement system 104 may monitor a performance of the published listing. For example, the user engagement system 104 may obtain user engagement data that indicates user engagement with the published listing, as well as a duration for which the listing has been posted. Additionally, or alternatively, the user engagement listing may indicate pricing information for the listing, such as a new (e.g., updated, different) maximum sale price for the item or a new minimum sale price for the item, which may also impact an average sale price for the item. The user engagement system 104 may use the user engagement data to iteratively refine and improve (e.g., retrain, fine-tune) the learning models 128. For example, the learning model manager 124 may periodically retrain the learning models using the updated user engagement data. The learning model manager 124 may update the models in real-time as new data becomes available. Further, the learning model manager 124 may apply information obtained for an item listing to improve predictions for similar or related items. The learning model manager 124 may identify and prioritize new data points for updating the trained learning models 140, which provides for the trained learning models 140 to continuously adapt to changing market conditions (e.g., trends) and user engagement, improving an accuracy of user engagement predictions and item information extraction.

In some examples, the user engagement system 104 may implement multiple threshold values 122 to perform automatic listing completion. For example, the user engagement system 104 may use a tiered approach where different threshold values 122 correspond to varying levels of automation. If the probability of user engagement 136 exceeds a first threshold value, then the user engagement system 104 may automatically complete an entirety of a listing automatically (e.g., without receiving user input indicating information for completing or filling one or more fields of the listing). For a probability of user engagement 136 falling between one or more second threshold values, the user engagement system 104 may automatically populate one or more of the fields of the listing, while leaving other fields of the listing for manual completion (e.g., one or more fields that do not lead to additional use of computational resources). For a probability of user engagement 136 that falls below a third threshold, the user engagement system 104 may provide a blank template of the item listing for manual completion (e.g., via user input). The tiered approach of automatic completion of listings provides for the user engagement system 104 to adapt a level of automation based on the predicted probability of user engagement 136, which may improve a balance between efficiency and accuracy in listing creation, as well as reduce the use of computational resources related to automatically completing item listings. The threshold values 122 and corresponding levels of automation may be dynamically adjusted based on ongoing performance data of listings and the user engagement system 104 (e.g., including user engagement data, as well as computational resource usage data) and user feedback.

The user engagement system 104 may leverage the learning models 128 to analyze input data 112 and context data 120 to improve computational resource allocation for listing items. For example, the user engagement system 104 may automatically generate listings for items or portions of listings for items with a probability of user engagement 136 that satisfies (e.g., is greater than) one or more threshold values 122. The user engagement system 104 may provide a configurable template for manual completion for items with a probability of user engagement 136 that fails to satisfy (e.g., is less than) the threshold values 122. Thus, by considering real-time market trends (e.g., conditions, dynamics) and historical user engagement data, the user engagement system 104 may improve computational resource allocation for listing creation and reduce the time items remain listed. The techniques described herein may enhance the efficiency of the marketplace and improve the user experience by prioritizing listings with higher potential for user engagement.

The user engagement system 104 may implement the model training logic 126 and the user engagement logic 138 by using servers that execute stored instructions to deploy various services of the user engagement system 104, such that those services perform numerous computations which are effective to provide the functionality described above and below. It is to be appreciated that the user engagement system 104 and/or the computing device 102 may include more, fewer, or different components without departing from the spirit or scope described herein.

Having considered an example of an environment, consider now a discussion of some example details of the techniques for dynamic automatic generation of item listings in accordance with one or more implementations.

### Automatic Generation of Item Listings

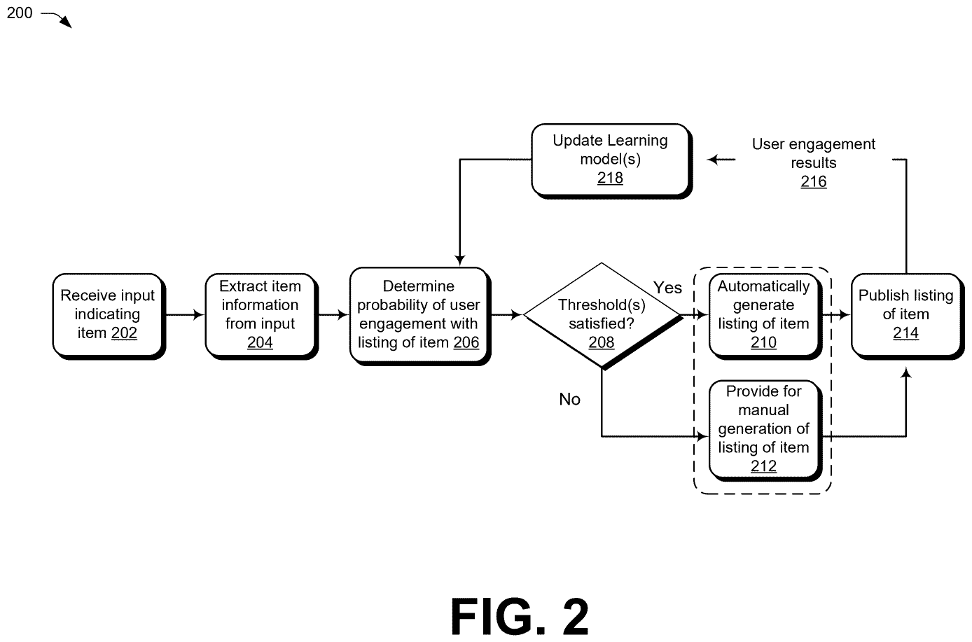

FIG. 2 depicts a procedure 200 in an example implementation of dynamic automatic generation of item listings. The procedure 200 may implement, or be implemented by, aspects of FIG. 1. For example, the procedure 200 may be implemented by a user engagement system and/or a computing device, such as the user engagement system 104 and the computing device 102 as described with reference to FIG. 1.

At 202, input indicating at least one item is received. For example, a user engagement system may receive input data indicating one or more items to be listed, such as images, videos, or descriptions of the items. In some examples, the input may indicate a single item, which is described in further detail with respect to FIG. 3. In some other examples, the input may indicate multiple items (e.g., a single image that includes multiple items), which is described in further detail with respect to FIG. 4. In some cases, a computing device may receive (e.g., obtain) the input via a user interface, such as responsive to a request displayed at the user interface. In some other cases, the computing device may utilize sensors or cameras to capture the input (e.g., automatically, or based on an indication from a user).

At 204, item information is extracted from the input. For example, a user engagement system may use trained learning models to extract relevant information about the item from the input. The user engagement system may implement one or more computer vision algorithms for image analysis, natural language processing for textual descriptions, or learning models for feature extraction. In some cases, the user engagement system may utilize CNNs to identify and classify visual attributes of items in images or videos. The user engagement system may store the extracted item information, such as at a data storage of the user engagement system. Additionally, or alternatively, the user engagement system may send the item information to one or more computing devices. The computing devices may store the item information locally to reduce latency in subsequent operations using the item information (e.g., automatic completion of item listings).

At 206, the probability of user engagement with the listing of the item is determined. The user engagement system may process the extracted item information, as well as context data, using trained learning models to generate a probability of user engagement, as described with reference to FIG. 1. For example, the user engagement system may provide the extracted item information and the context data as input to the trained learning models and may receive the probability of user engagement as output. The context data may describe one or more market trends or patterns in historical user engagement data. A user engagement system and/or a computing device may obtain the context data from one or more applications. Example context data includes, but is not limited to, historical user engagement with listings of a same item or related item (e.g., a same category as the item), seasonal fluctuations in user engagement, and a geographic location of users engaging with a same item or related item. In some cases, the user engagement system and/or computing device may obtain (e.g., determine, receive) the context data through application programming interfaces (APIs) connected to online marketplace applications or platforms, social media analytics tools, or internal databases tracking user engagement (e.g., behavior) across multiple platforms.

At 208, a user engagement system determines whether one or more threshold values are satisfied. For example, the user engagement system may compare the probability of user engagement to the threshold values. If the thresholds are satisfied (e.g., “Yes”), then at 210, the listing of the item is automatically generated. For example, the user engagement system may indicate for the computing device to output a control selectable via user input to automatically generate the item listing. If the control is selected, then the computing device may automatically generate the item listing using the context data and the extracted information. If the control is not selected, then the computing device may not generate the item listing. In some other examples, the user engagement system may automatically generate the item listing without further user input.

If the thresholds are not satisfied (e.g., “No”), then at 212, manual generation of the listing of the item is provided. For example, the user engagement system may indicate for the computing device to output a control selectable via user input to manually complete one or more fields of a configurable template for listing the item. The computing device may receive user input that indicates one or more values for the fields of the configurable template. The computing device may complete the fields of the configurable template with the values.

At 214, the listing of the item is published. For example, the user engagement system or another system of an online marketplace application may make the listing visible and accessible to other users of the online marketplace application. In some cases, publishing the listing may include indexing the listing in a searchable database of the online marketplace application, assigning the listing to relevant categories, and activating features selected for the listing. The user engagement system may also notify one or more users of the online marketplace application about publishing the listing (e.g., by displaying a notification at a user interface of a computing device).

At 216, user engagement results are collected. The user engagement system may monitor and collect data on user interactions with the published listing. At 218, the results are used to update the learning models used in determining the probability of user engagement. For example, the user engagement system may use the collected user engagement data to retrain (e.g., fine-tune, update) and improve the learning models, enhancing the accuracy of future user engagement predictions.

FIG. 3 depicts an example of a user interface 300 for listing a single item based on user engagement. The user interface 300 may implement, or be implemented by, aspects of FIGS. 1 and 2. For example, the user interface 300 may be implemented by a user engagement system and/or a computing device, such as the user engagement system 104 and the computing device 102 as described with reference to FIG. 1.

The user interface 300 may include an item context display 302 that shows input data 112, which in this case is an image of a shoe. The item context display 302 include a “My net worth” value that indicates a total value of one or more items identified (e.g., detected, determined) in the input data 112. For example, a net worth of the items in the input data 112 (e.g., the shoe) may be a value of $100.

The item context display 302 may include a display of item data 304 for the items identified in the input data 112. For example, a user engagement system may obtain item information from the input data 112, as well as context data, which may include the item data 304. For example, the item data 304 may include, but is not limited to, an indication of whether the item is trending (e.g., “HOT ITEM”), an identifier (ID) of the item (e.g., an assigned product ID and/or a description of the item including an item type, a brand, or another information), an item category, and a suggested price (e.g., $100). The displayed net worth may be a sum of the suggested prices for the items identified in the input data 112.

The item context display 302 may include display of context data of the identified items. For example, the item context display 302 may include average price data 306, which includes an average sold price (e.g., $100) and a sold price range (e.g., $80-$120) for the item or similar items. Additionally, or alternatively, the item context display 302 may include market demand data 308, which includes a total items sold value (e.g., 2,500), sell-through rate, and/or a total numerical quantity (e.g., number, amount) of sellers (e.g., 300). Additionally, or alternatively, the item context display 302 may include sales data 310 that shows a total item sales value (e.g., 1.2 m). The item context display 302 may additionally, or alternatively, display context data not shown, such as shipping information or other context data.

The item context display 302 may include one or more visual representations of the context data. For example, the item context display 302 may include a price graph 312, such as an average sold price graph. The price graph 312 may be a visual display of a sold price of the item ranging from $0 to $150 (e.g., a maximum sold price of the item). Although the user interface 300 is illustrated as including a visual representation of the average price data 306, the user interface 300 may include visual representations of any of the context data.

In some examples, the item context display 302 may include one or more controls selectable to generate a listing of an item. For example, if a probability of user engagement with the item is greater than one or more threshold values (e.g., for items with an indication that the item is trending), then the item context display 302 may include an AI listing control 314 labeled “List with AI” and a manual listing control 316 labeled “List manually.” If the probability of user engagement with the item is less than the threshold values (e.g., for items that are not trending), then the item context display 302 may include a manual listing control 316 without an AI listing control 314.

In some cases, the item context display 302 may include an input control 318 labeled “Choose another photo” selectable to provide additional input data 112. For example, a user may select the input control 318 to upload additional images with items. If the user selects the control, then the item data 304 may remain in the item context display 302 for later reference (e.g., when generating an item listing).

FIG. 4 depicts an example of a user interface 400 for listing multiple items based on user engagement. The user interface 400 may implement, or be implemented by, aspects of FIGS. 1, 2, and 3. For example, the user interface 400 may be implemented by a user engagement system and/or a computing device, such as the user engagement system 104 and the computing device 102 as described with reference to FIG. 1.

The user interface 400 may include an item context display 402 that shows input data 112, which includes an image of multiple items including a jacket, shoes, and glasses. The item context display 402 includes a “My net worth” value that indicates a total value of the items identified in the input data 112. For example, a net worth of the items in the input data 112 may be a value of $300, which includes a value of the jacket, a value of the shoes, and a value of the glasses.

The item context display 402 may include a display of item data 404 of the jacket, item data 406 of the shoes, and item data 408 of the glasses. The item data 404, the item data 406, and the item data 408 may include information or details related to the corresponding items identified in the input data 112. For example, a user engagement system may obtain item information from the input data 112, as well as context data, which may include the item data 404, the item data 406, and the item data 408. The item data may include, but is not limited to, an indication of whether the item is trending (e.g., “HOT ITEM”), an ID of the item, an item category, and a suggested price. The displayed net worth may be a sum of the suggested prices for the items identified in the input data 112.

The item data 404, the item data 406, and the item data 408 may include a listing indicator 410, a listing indicator 412, and a listing indicator 414, respectively. The listing indicators may provide for selection of multiple items for listing (e.g., using AI or for listing manually). For example, the item context display 402 may include one or more controls selectable to generate listings for the items. The item context display 402 includes an AI listing control 416 labeled “List with AI” and a manual listing control 418 labeled “List manually.” If the user selects the AI listing control 416, then the user may also select one or more of the items eligible to be listed with AI. The items eligible to be listed with AI may include items with a probability of user engagement that satisfies (e.g., is greater than) one or more threshold values, such as the items that are trending. For example, the jacket and the shoes may be eligible to be listed with AI, while the glasses may not be eligible to be listed with AI.

Thus, the listing indicator 410 and the listing indicator 412 may be selectable if the list with AI control 416 is selected, while the listing indicator 414 may not be selectable. Additionally, or alternatively, if the list manual listing control 418 is selected, then the listing indicator 410, the listing indicator 412, and the listing indicator 414 may be selectable. A computing device and/or a user engagement system may generate listings for items with the listing indicators that are selected, such that a user may enable bulk listing generation.

In some cases, the item context display 402 may include an input control 420 labeled “Choose another photo” selectable to provide additional input data 112. For example, a user may select the input control 420 to upload additional images with items. If the user selects the control, then the item data 404, the item data 406, and the item data 408 may remain in the item context display 402 for later reference (e.g., when generating an item listing).

### Example Procedures

This section describes examples of procedures for dynamic automatic generation of item listings. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

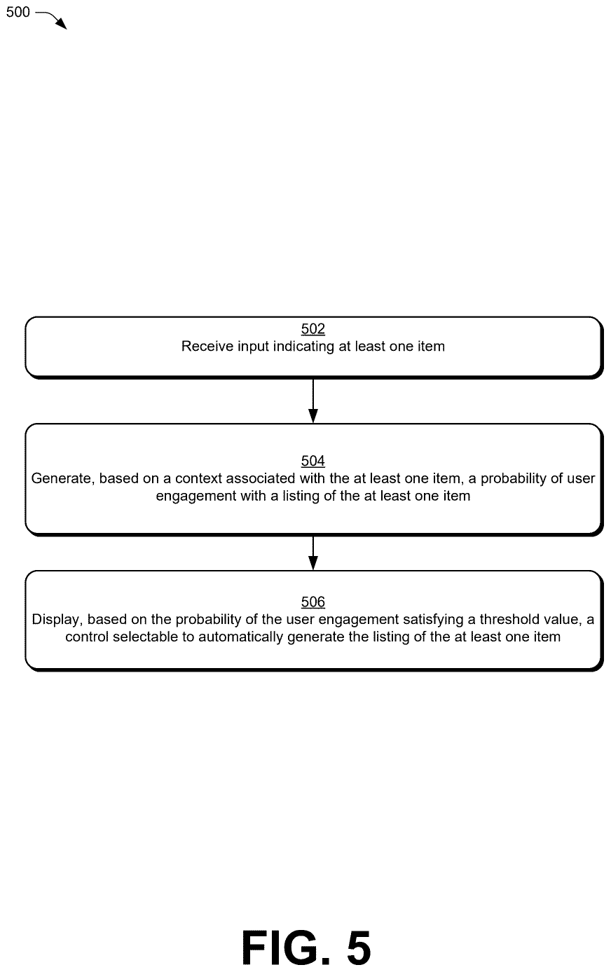

FIG. 5 depicts a procedure 500 in an example implementation of dynamic automatic generation of item listings.

At 502, input indicating at least one item is received. A computing device may obtain (e.g., via user input and/or via one or more camera sensors) the input and may send the input to a user engagement system. The input may include, but is not limited to, images of one or more items, a video of the items, a text description of the items, or any other digital content that indicates the items.

At 504, a probability of user engagement with a listing of the at least one item is generated based on a context associated with the at least one item. The context may include, but is not limited to, an average value (e.g., an average price) associated with the item, an average value (e.g., an average price) of related items, a volume of user engagement with the item, or a volume of user engagement with related items. For example, the context may include information related to the current market conditions (e.g., trends) and historical engagement data for items indicated by the input and/or items related to (e.g., similar to, in a same category as, used in accordance with) the items. The market trends may include factors, such as average selling prices of items in an online marketplace, current user engagement trends with listings in the online marketplace, seasonal variations, and past user engagement metrics for comparable (e.g., related, similar) listings.

To generate the probability of user engagement with the item, a computing device (e.g., or a user engagement system) may obtain data corresponding to respective contexts for items listed in an online marketplace application. The computing device (e.g., or a user engagement system) can then train at least one learning model using the data to output the probability of user engagement with the listing based on the input indicating the item and an associated context.

At 506, a control selectable to automatically generate the listing of the at least one item is displayed based on the probability of the user engagement satisfying a threshold value. The threshold value may be obtained (e.g., by a computing device or a user engagement system) as output from a learning model or received as additional input via a user interface.

If the control is selected to generate the listing, the computing device (e.g., or a user engagement system) generates the listing of the item and displays it with an additional control selectable to publish the listing. Generating the listing may involve obtaining output from at least one learning model that indicates information, such as a description, category, value, or condition of the item. The information is used to automatically complete multiple fields of a configurable template for the listing (e.g., by a computing device or a user engagement system).

Additionally, or alternatively, the computing device or user engagement system obtain updated data corresponding to an updated context for the listed item, where the updated data includes user engagement data that describes user engagement with the listing of the item. The computing device or user engagement system retrain (e.g., fine-tune, update) the learning model using the updated data to output an updated probability of user engagement with the listing using the input and updated context.

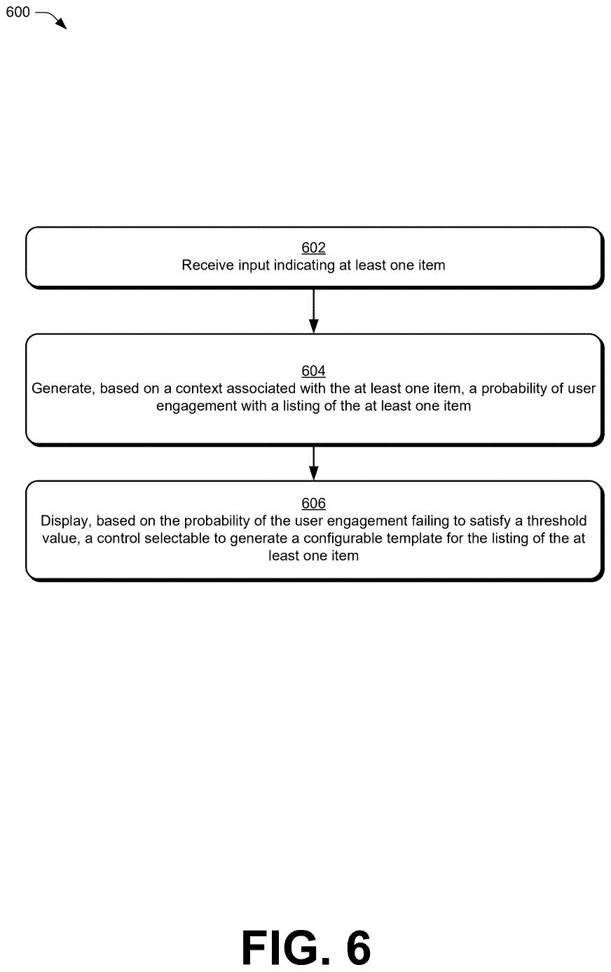

FIG. 6 depicts a procedure 600 in an example implementation of dynamic automatic generation of item listings.

At 602, input indicating at least one item is received. A computing device may obtain the input via user interaction with a user interface and/or via one or more sensors (e.g., camera sensors). The input may include, but is not limited to, one or more images of the item, a video of the item, or a textual description of the item.

At 604, a probability of user engagement with a listing of the at least one item is generated based on a context associated with the at least one item. The context may include factors, such as an average value associated with the item, an average value of related items, a volume of user engagement with the item, or a volume of user engagement with related items. The factors may include current market trends, historical engagement data, and other relevant information for the item and related items.

To generate this probability, a computing device or user engagement system may obtain data corresponding to respective contexts for items in the online marketplace. The computing device or user engagement system can then train at least one learning model using this data to output the probability of user engagement with the listing based on the input indicating the item and its associated context.

At 606, a control selectable to generate a configurable template for the listing of the at least one item is displayed based on the probability of the user engagement failing to satisfy a threshold value. The threshold value may be obtained as output from a learning model or received as additional input. If the control is selected to generate the configurable template, the computing device or user engagement system receives the selection, generates the configurable template for the listing of the at least one item, and displays the configurable template. The configurable template includes a set of fields for completion (e.g., for manual completion by user input).

The computing device or user engagement system may then obtain additional input that indicates information associated with the listing of the at least one item. The information may include one or more of a description of the item, a category of the item, a value of the item, or a condition of the item. The computing device or user engagement system uses the information to complete the set of fields in the template and displays the listing of the item with an additional control selectable to publish the listing.

In some cases, the computing device or user engagement system refrains from displaying an additional control selectable to automatically generate the listing of the item if the probability of user engagement fails to satisfy the threshold value. In some examples, the computing device or user engagement system may also obtain updated data that includes an updated context of the item. The updated data may include user engagement data that indicates user engagement with the listing of the item. The computing device or user engagement system may retrain (e.g., fine-tune, update) the learning models using the updated data to output an updated probability of user engagement with the listing based on the input and updated context.

Having described examples of procedures in accordance with one or more implementations, consider now an example of a system and device that can be utilized to implement the various techniques described herein.

### Example System and Device

FIG. 7 illustrates an example of a system generally at 700 that includes an example of a computing device 702 that is representative of one or more computing systems and/or devices that may implement the various techniques described herein. This is illustrated through inclusion of the application 108 and the user engagement system 104. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 706 is illustrated as including memory/storage 712. The memory/storage 712 represents memory/storage capacity associated with one or more computer-readable media. The memory/storage 712 may include volatile media (such as random-access memory (RAM)) and/or nonvolatile media (such as read only memory (ROM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving input indicating at least one item;
generating, based on a context associated with the at least one item, a probability of user engagement with a listing of the at least one item; and
displaying, based on the probability of the user engagement satisfying a threshold value, a control selectable to automatically generate the listing of the at least one item.

2. The computer-implemented method of claim 1, further comprising:
obtaining data corresponding to respective contexts associated with a plurality of items comprising the at least one item; and
training, using the data, at least one learning model to output the probability of the user engagement with the listing of the at least one item based on the input indicating the at least one item and the context associated with the at least one item.

3. The computer-implemented method of claim 2, further comprising:
obtaining updated data corresponding to an updated context associated with the at least one item, wherein the updated data corresponds to the user engagement with the listing of the at least one item; and
retrain, using the updated data, the at least one learning model to output an updated probability of the user engagement with the listing of the at least one item based on the input indicating the at least one item and the updated context associated with the at least one item.

4. The computer-implemented method of claim 1, further comprising:
receiving, at the control, a selection to generate the listing of the at least one item;
generating the listing of the at least one item; and
displaying the listing of the at least one item with an additional control selectable to publish the listing of the at least one item.

5. The computer-implemented method of claim 4, wherein generating the listing of the at least one item further comprises:
obtaining an output from at least one learning model that indicates information associated with the listing of the at least one item, wherein the information comprises one or more of a description of the at least one item, a category of the at least one item, a value of the at least one item, or a condition of the at least one item; and
automatically completing, using the information, a plurality of fields of a configurable template for the listing of the at least one item.

6. The computer-implemented method of claim 1, further comprising obtaining, as output from a learning model, the threshold value.

7. The computer-implemented method of claim 1, further comprising receiving additional input indicating the threshold value.

8. The computer-implemented method of claim 1, wherein the input comprises one or more images of the at least one item.

9. The computer-implemented method of claim 1, wherein the context associated with the at least one item is based on one or more of an average value associated with the at least one item, an average value associated with one or more items related to the at least one item, a volume of user engagement with the at least one item, or a volume of user engagement with the one or more items related to the at least one item.

10. A system comprising:
one or more processors; and
a computer-readable storage medium storing instructions that are executable by the one or more processors to perform operations comprising:
receiving input indicating at least one item;
generating, based on a context associated with the at least one item, a probability of user engagement with a listing of the at least one item; and
displaying, based on the probability of the user engagement satisfying a threshold value, a control selectable to automatically generate the listing of the at least one item.

11. A computer-implemented method comprising:
receiving input indicating at least one item;
generating, based on a context associated with the at least one item, a probability of user engagement with a listing of the at least one item; and
displaying, based on the probability of the user engagement failing to satisfy a threshold value, a control selectable to generate a configurable template for the listing of the at least one item.

12. The computer-implemented method of claim 11, further comprising:
obtaining data corresponding to respective contexts associated with a plurality of items comprising the at least one item; and
training, using the data, at least one learning model to output the probability of the user engagement with the listing of the at least one item based on the input indicating the at least one item and the context associated with the at least one item.

13. The computer-implemented method of claim 12, further comprising:
obtaining updated data corresponding to an updated context associated with the at least one item, wherein the updated data corresponds to the user engagement with the listing of the at least one item; and
retrain, using the updated data, the at least one learning model to output an updated probability of the user engagement with the listing of the at least one item based on the input indicating the at least one item and the updated context associated with the at least one item.

14. The computer-implemented method of claim 11, further comprising:
receiving, at the control, a selection to generate the configurable template for the listing of the at least one item;
generating the configurable template for the listing of the at least one item; and
displaying the configurable template for the listing of the at least one item, wherein the configurable template comprises a plurality of fields for completion.

15. The computer-implemented method of claim 14, wherein further comprising:
obtaining additional input that indicates information associated with the listing of the at least one item, wherein the information comprises one or more of a description of the at least one item, a category of the at least one item, a value of the at least one item, or a condition of the at least one item;
completing, using the information, the plurality of fields; and
displaying the listing of the at least one item with an additional control selectable to publish the listing of the at least one item.

16. The computer-implemented method of claim 11, further comprising refraining from displaying an additional control selectable to automatically generate the listing of the at least one item based on the probability of the user engagement failing to satisfy the threshold value.

17. The computer-implemented method of claim 11, further comprising obtaining, as output from a learning model, the threshold value.

18. The computer-implemented method of claim 11, further comprising receiving additional input indicating the threshold value.

19. The computer-implemented method of claim 11, wherein the input comprises one or more images of the at least one item.

20. The computer-implemented method of claim 11, wherein the context associated with the at least one item is based on one or more of an average value associated with the at least one item, an average value associated with one or more items related to the at least one item, a volume of user engagement with the at least one item, or a volume of user engagement with the one or more items related to the at least one item.
